(19) United States
(12) Patent Application Publication
(10) Pub. No.: US 2019/0009432 A1
(43) Pub. Date: Jan. 10, 2019

(54) MIXTURE OF SYNTHETIC RESIN AND WEIGHT BODY MATERIAL AND METHOD OF MANUFACTURING THE SAME

(71) Applicants: BU-KWANG TECH CO., LTD., Gimhae-si (KR); INGEN CO., LTD., Gwangju-si (KR)

(72) Inventor: Yong Je SONG, Gimhae-si (KR)

(21) Appl. No.: 16/055,917

(22) Filed: Aug. 6, 2018

Related U.S. Application Data
(63) Continuation of application No. PCT/KR2017/000809, filed on Jan. 24, 2017.

(30) Foreign Application Priority Data
Feb. 4, 2016 (KR) 10-2016-0014517

(51) Int. Cl. B29B 13/02; B29B 7/26; B29C 45/00; B29C 45/47; B29C 45/72; B29C 45/73

(52) U.S. Cl. CPC B29B 13/022; B29B 7/26; B29C 45/0001; B29K 2023/12; B29C 45/7207; B29C 45/73; B29K 2023/06; B29C 45/47

(57) ABSTRACT

A method of manufacturing a mixture of synthetic resin and weight body material added to increase the weight of the mixture is disclosed. The method includes a first step of introducing synthetic resin and weight body material into the mixer, a second step of mixing the synthetic resin and the weight body material in the mixer, a third step of discharging a fixed amount of the mixture of synthetic resin and weight body material, mixed in the mixer, a fourth step of melting the synthetic resin discharged from the mixer, a fifth step of molding the molten synthetic resin and the weight body material into a finished product using the injector, in which the mold is mounted, and a sixth step of cooling the finished product. The method is configured to perform injection molding using environmentally friendly materials and regenerated energy resources, whereby production time is reduced compared to a conventional mortar injection and extrusion type injection method while improving productivity. In addition, the manufacturing process is simplified, thereby reducing labor costs. Furthermore, the defect rate is reduced, thereby improving quality. Moreover, poorly processed materials are pulverized for reuse, thereby reducing waste treatment costs and the consumption of raw materials and thus improving price competitiveness.

### TECHNICAL FIELD

The present invention relates to a mixture of synthetic resin and weight body material added to increase the weight of the mixture and a method of manufacturing the same, and more particularly, to a mixture of synthetic resin and weight body material manufactured using a mixer for mixing synthetic resin and weight body material and an injector for injection-molding the synthetic resin and the weight body material mixed by the mixer and a method of manufacturing the same.

### BACKGROUND ART

In general, a balance weight, which is manufactured by extruding concrete, or a counter balance, which is manufactured by casting metal, is used as a counter weight for balancing weight.

Conventional methods of manufacturing counter weights have disadvantages in that production efficiency is low, manufacturing costs are high due to the use of high-priced raw materials, and noxious materials are emitted from products manufactured using the conventional methods.

Therefore, there is a high necessity for a product that exhibits high durability, chemical resistance, and temperature resistance and that satisfies requirements related to noxious materials depending on weather and other conditions, such as a counter weight.

A balance weight is used in electric home appliances, such as a washing machine and a dishwasher, and a counter balance is used in an elevator, a crane, a forklift, and other kinds of heavy equipment. In addition, the counter balance may also be used in various kinds of industries, such as the construction, building material (e.g. bricks, pavement blocks, tiles, and ceiling materials), automobile, and ocean industries (e.g. n aquaculture industry and fishery supplies).

Weight body material is included in the balance weight and the counter balance.

The weight body material is added to increase the weight of synthetic resin products.

In addition, it is possible to reduce the amount of resources that are wasted in various industries by developing and mass-producing materials from waste that are capable of substituting for new materials based on a green industry and to reduce the amount of waste that is discharged, thereby reducing costs related to waste treatment in various industries while observing environmental protection policies.

First, data related to industrial waste in the year 2014 show that the amount of concrete waste accounts for about 80% of all industrial waste (see data provided by Korea Environment Corporation).

Therefore, there is a high necessity for manufacturing and supplying a product using a material that is capable of substituting for concrete.

Second, there is a high necessary for using “regenerated energy resources” based on green industry.

Regenerated energy resources (e.g. iron ore sludge generated as waste in the iron ore industry and various plastic resins (PP, PE, and PC) generated as waste in the plastic industry) may be used.

Third, there is a high necessity for manufacturing an environmentally friendly material that satisfies requirements related to noxious materials and is capable of substituting for lead (Pb), which is used in ocean industries, particularly industries related to seaweed, fish and shellfish, and aquaculture.

An example of the prior art related to an apparatus and method for manufacturing a mixture of synthetic resin and weight body material is disclosed in Korean Patent Application Publication No. 2005-0004709, which provides an apparatus for injection-molding a balance product including a mixture of plastic and iron powder, wherein a product mold is installed in front of a nozzle formed at the front end of an injection plunger body, a hydraulic (pneumatic) cylinder (or an injection servo motor) is installed at the rear end of the injection plunger body, and an inlet port is formed in the upper part of the front side thereof, characterized in that an outlet port formed in a mixture conveyance cylinder having a screw extending at regular intervals and configured to be rotated by a low-speed motor is connected to the inlet port, a heater is attached to a vertical circumferential wall in the cylinder, a conveyance pipe connected to a plastic extrusion cylinder having a heater attached to the circumferential surface thereof and a conveyance pipe connected to an iron powder hopper having a heater attached to the circumferential surface thereof are connected to an inlet port formed in the upper part of the mixture conveyance cylinder, the extrusion cylinder is installed in the horizontal direction, a hydraulic (pneumatic) cylinder (or an injection servo motor) is installed at a rod of a screw installed in the extrusion cylinder and extending at regular intervals, and a plastic material hopper having a supply amount adjustment port is installed at one side of the upper part thereof.

Another example of the prior art related to a method of manufacturing a ceramic injection material having a high specific gravity, which is used as a fishing weight or a fishing net weight, is disclosed in Korean Registered Patent No. 0332997, which provides a method of manufacturing a ceramic injection material having a high specific gravity including preparing 24% of PVC, 20% of ceramic powder having aluminum oxide as a main gradient, 50% of barium, 4% of dioctyl adipate (DOA), and 2% of a stabilizer as the injection material, introducing the PVC into a mixing barrel and primarily heating the PVC, secondary introducing the DOA into the mixing barrel when the temperature in the mixing barrel is about 100° C., introducing the ceramic, the barium, and the stabilizer into the mixing barrel when the temperature in the mixing barrel is about 100 to 120° C., mixing the introduced materials, introducing the mixture into an extruder having an inner temperature of about 195° C. such that the mixture is melted in the extruder, extruding the molten mixture from the extruder, forming the mixture extruded from the extruder into a plate having a uniform thickness, and cooling and pulverizing the plate.

However, the conventional mixture of synthetic resin and weight body material has a complicated shape and is difficult to manufacture. In addition, the process of manufacturing the mixture is complicated due to the complicated shape thereof. As a result, a lot of time is necessary to manufacture a finished product, whereby productivity is lowered.

### DESCRIPTION OF EMBODIMENTS

### Technical Problem

An object of the present invention is to provide a mixture of synthetic resin and weight body material that is capable of reducing manufacturing time, thereby improving productivity, of reducing labor costs and production time incurred when a conventional mortar injection and extrusion type injection method is used, and of reusing poorly processed materials through pulverization, thereby reducing product costs and thus improving price competitiveness, and a method of manufacturing the same.

### Solution to Problem

To achieve these objects and other advantages and in accordance with the purpose of the invention, as embodied and broadly described herein, a method of manufacturing a mixture of synthetic resin and weight body material added to increase the weight of the mixture includes a first step of introducing synthetic resin and weight body material into a mixer, a second step of mixing the synthetic resin and the weight body material in the mixer, a third step of discharging a fixed amount of the mixture of synthetic resin and weight body material, mixed in the mixer, a fourth step of melting the synthetic resin discharged from the mixer, a fifth step of molding the molten synthetic resin and the weight body material into a finished product using an injector, in which a mold is mounted, and a sixth step of cooling the finished product.

### Advantageous Effects of Disclosure

The present invention is configured to perform injection molding using environmentally friendly materials and regenerated energy resources, whereby the production time is reduced compared to a conventional mortar injection and extrusion type injection method. Consequently, the present invention has the effect of improving productivity. In addition, the manufacturing process is simplified. Consequently, the present invention has the effect of reducing labor costs. Furthermore, the defect rate is reduced. Consequently, the present invention has the effect of improving quality.

Moreover, poorly processed materials are pulverized for reuse. Consequently, the present invention has the effect of reducing waste treatment costs and the consumption of raw materials, thereby improving price competitiveness.

### BRIEF DESCRIPTION OF THE DRAWINGS

FIG. 1 is a flowchart showing a manufacturing method performed by an apparatus for injecting a mixture of synthetic resin and weight body material according to the present invention;

FIG. 2 is a front view schematically showing a mixer installed in the apparatus for injecting the mixture of synthetic resin and weight body material according to the present invention;

FIG. 3 is a side view schematically showing an injector installed in the apparatus for injecting the mixture of synthetic resin and weight body material according to the present invention;

FIG. 4 is a front view schematically showing the injector installed in the apparatus for injecting the mixture of synthetic resin and weight body material according to the present invention;

FIG. 5 is a view schematically showing a heating extrusion unit of the injector installed in the apparatus for injecting the mixture of synthetic resin and weight body material according to the present invention;

FIG. 6 is a perspective view of a preheater installed in the apparatus for injecting the mixture of synthetic resin and weight body material according to the present invention;

FIG. 7 is a side view of the preheater installed in the apparatus for injecting the mixture of synthetic resin and weight body material according to the present invention; and

FIG. 8 is a sectional view schematically showing another embodiment of the preheater installed in the apparatus for injecting the mixture of synthetic resin and weight body material according to the present invention.

### MODE OF DISCLOSURE

The present invention provides a method of manufacturing a mixture of synthetic resin and weight body material including a first step of introducing synthetic resin and weight body material into the mixer 100, a second step of mixing the synthetic resin and the weight body material in the mixer 100, a third step of discharging a fixed amount of the mixture of synthetic resin and weight body material, mixed in the mixer 100, a fourth step of melting the synthetic resin discharged from the mixer 100, a fifth step of molding the molten synthetic resin and the weight body material into a finished product using the injector 200, in which the mold is mounted, and a sixth step of cooling the finished product.

The weight body material is any one selected from between iron oxide and aluminum oxide, and the weight of the weight body material is 10 to 75% of the total weight of the mixture.

The synthetic resin is any one selected from between regenerated polypropylene (PP) and regenerated polyethylene (PE).

The mixture further includes 0.3 to 5 weight % of a coloring agent, 10 to 20 weight % of a filler, 0.2 to 1 weight % of a processing aid, 0.2 to 0.5 weight % of an antioxidant, and 0.3 to 5 weight % of a compound. The remainder of the mixture is the synthetic resin.

Hereinafter, a mixture of synthetic resin and weight body material and a method of manufacturing the same will be described in detail with reference to the accompanying drawings.

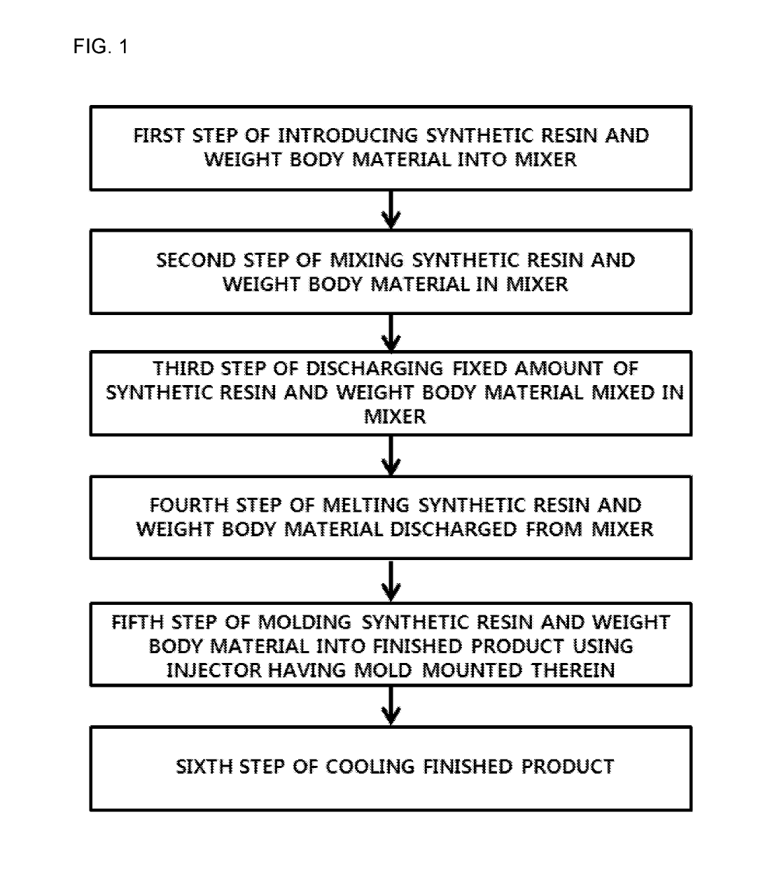

FIG. 1 is a flowchart showing a manufacturing method performed by an apparatus for injecting a mixture of synthetic resin and weight body material according to the present invention.

As shown in FIG. 1, a method of manufacturing a mixture of synthetic resin and weight body material added to increase the weight of the mixture includes a first step of introducing synthetic resin and weight body material into a mixer 100.

Here, the synthetic resin is any one selected from between regenerated polypropylene (PP) and regenerated polyethylene (PE).

The mixture further includes 0.3 to 5 weight % of a coloring agent, 10 to 20 weight % of a filler, 0.2 to 1 weight % of a processing aid, 0.2 to 0.5 weight % of an antioxidant, and 0.3 to 5 weight % of a compound. The remainder of the mixture is the synthetic resin.

The weight of the weight body material is 10 to 75% of the total weight of the mixture.

In particular, the weight body material is any one selected from between iron oxide and aluminum oxide.

Well-known PP or PE materials are used as the coloring agent, the filler, the processing aid, the antioxidant, and the compound.

For reference, the coloring agent is used to color various materials (e.g. plastic, rubber, paper, fiber, and leather), and the filler is a chemically inert material that is added to an adhesive in order to adjust the viscosity of synthetic resin and to prevent hardened resin from cracking while reducing costs. The filler does not contribute to the adhesive force.

If less than 0.3 weight % of the coloring agent is added, coloring is not satisfactorily achieved. If more than 5 weight % of the coloring agent is added, coloring effects are not further improved, which leads to a reduction in economic efficiency.

Paints and dyes are used for coloring. Carbon black, titanium white, and chrome yellow are used as the paints, and oil yellow, oil blue, and oil red are used as the dyes.

In general, master-batch coloring agents are used.

The processing aid is used to improve the processability of synthetic resin and the process efficiency of mixing and molding. If less than 0.2 weight % of the processing aid is added, processability is lowered. If more than 1 weight % of the processing aid is added, effects are not further improved.

In general, a mixture of silica and silicon is used as the processing aid.

The filler is added to improve the physical properties of molded products. If less than 10 weight % of the filler is added, the effects are insignificant. If more than 20 weight % of the filler is added, the physical properties of the molded products are changed.

Glass fiber, calcium carbonate, talcum, mica, silica, wood powder, or chalk is used as the filler. In recent years, magnesium hydroxide (Mg(OH)₂) has been used as the filler.

The antioxidant is used to prevent various materials from oxidizing at high temperature.

If less than 0.2 weight % of the antioxidant is added, oxidation is satisfactorily achieved. If more than 0.5 weight % of the antioxidant is added, the effects of preventing oxidation are insignificant, which leads to a low ratio of effect to cost.

A phenol-based antioxidant, a sulfur-based antioxidant, or a phosphorus-based antioxidant may be used as the antioxidant. Typically, an FDA-approved phenol-based antioxidant, represented by BHT, is used as the antioxidant.

In addition, the compound is a material that assists in satisfactory mixing of synthetic resin and iron ore. If less than 0.3 weight % of the compound is added, mixing of synthetic resin and iron ore is not satisfactorily achieved. If more than 5 weight % of the compound is added, the mixture is too dilute.

In general, lime powder having silica (SiO₂) added thereto is used as the compound.

At a second step, the synthetic resin and the weight body material, introduced into the mixer 100, are mixed in the mixer 100.

At a third step, a fixed amount of the mixture of synthetic resin and weight body material, mixed in the mixer 100, is discharged from the mixer 100.

At a fourth step, the synthetic resin discharged from the mixer 100 is melted.

The synthetic resin is heated at a temperature of 300 to 400° C.

The weight body material is not melted, since the weight body material is a metal material.

At a fifth step, the synthetic resin and the weight body material, melted at the fourth step, are molded into a finished product using an injector 200, in which the mold is mounted.

At a sixth step, the finished product is cooled.

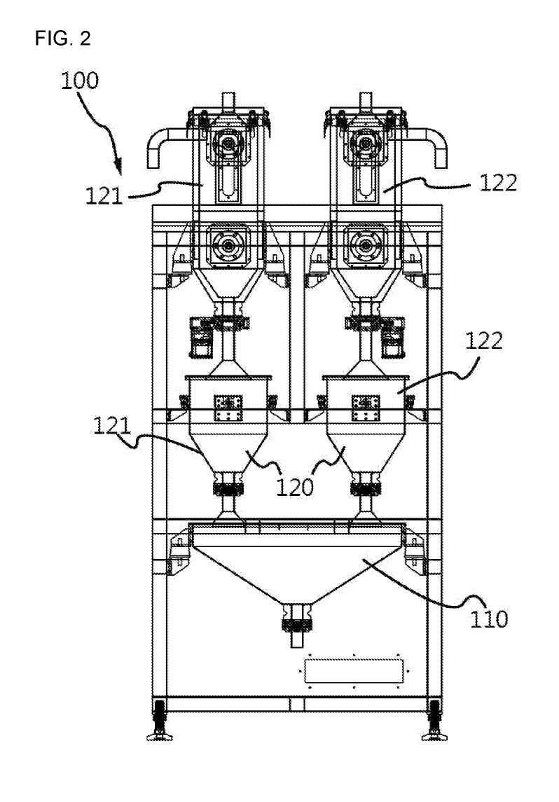

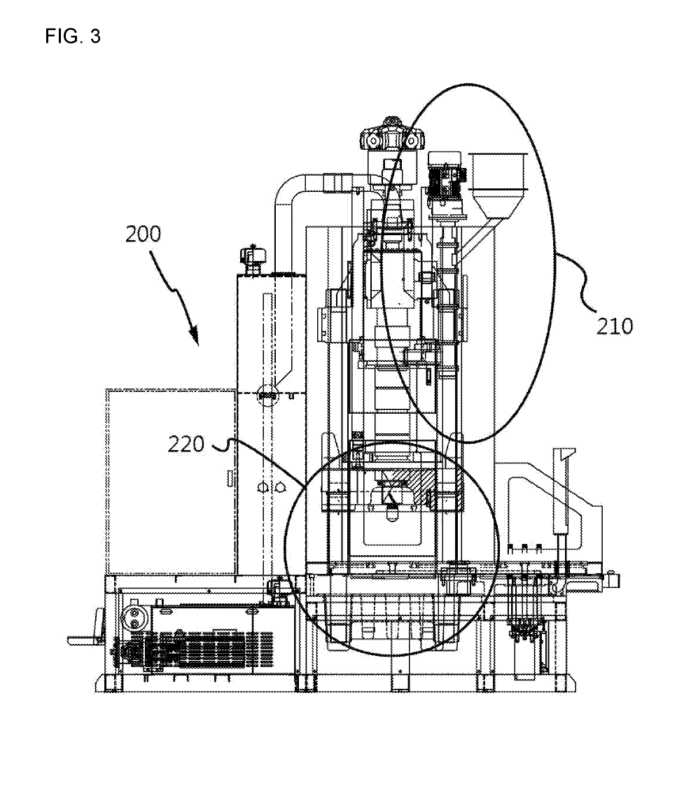

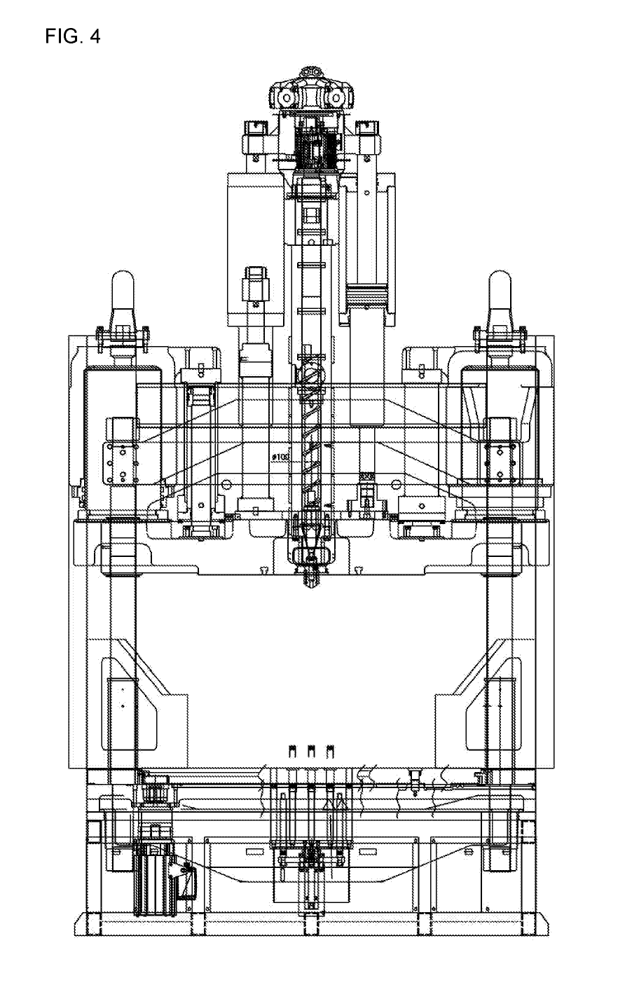

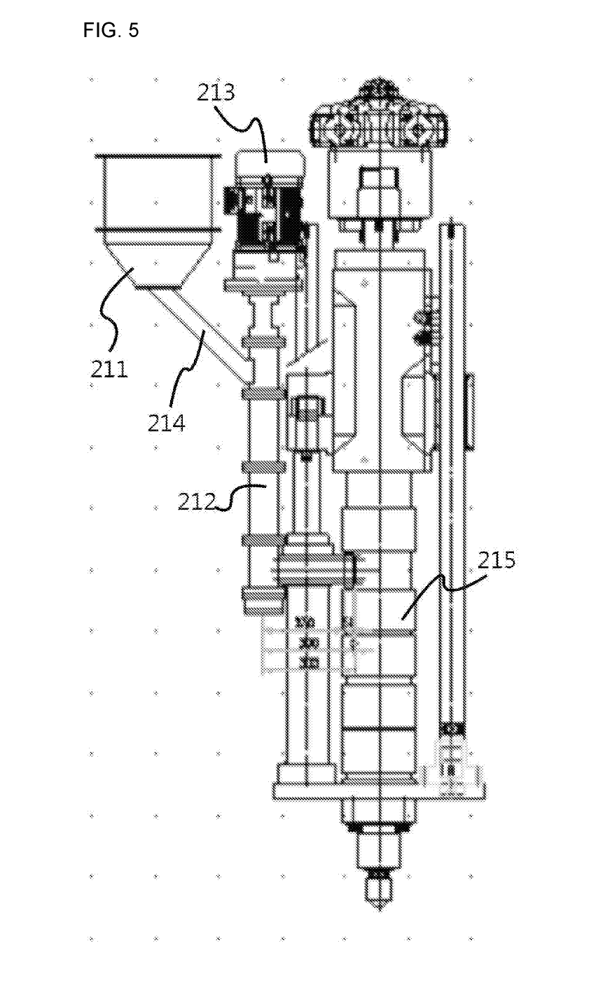

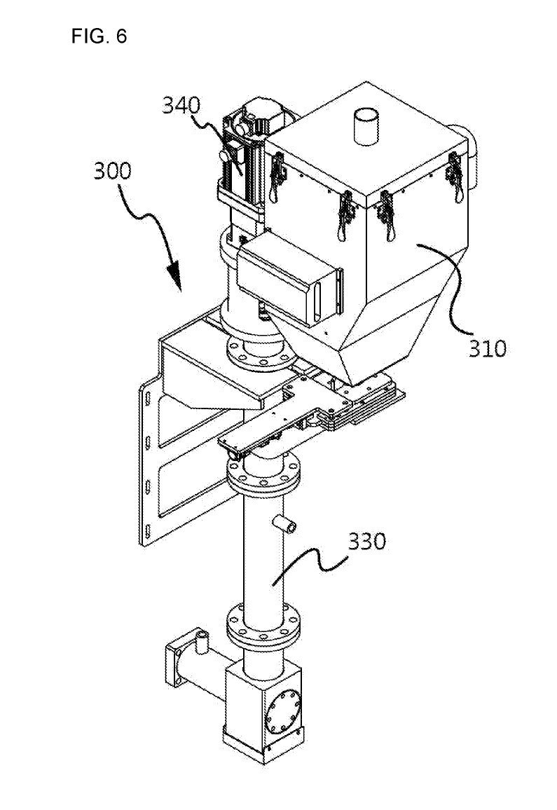

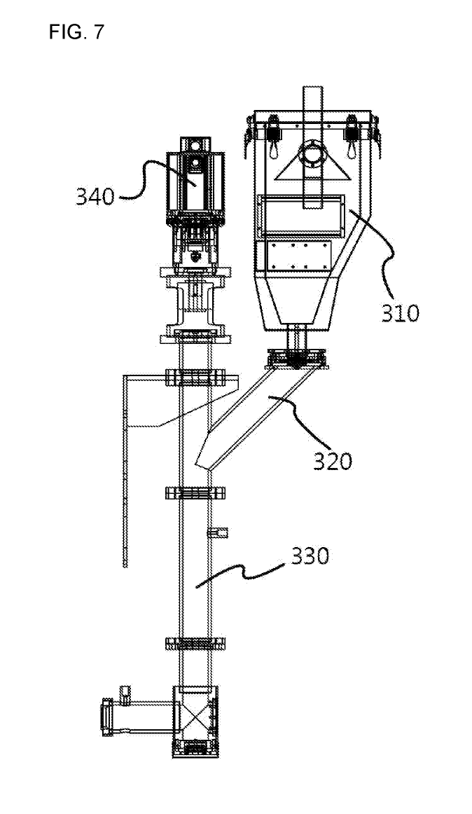

FIG. 2 is a front view schematically showing a mixer installed in the apparatus for injecting the mixture of synthetic resin and weight body material according to the present invention, FIG. 3 is a side view schematically showing an injector installed in the apparatus for injecting the mixture of synthetic resin and weight body material according to the present invention, FIG. 4 is a front view schematically showing the injector installed in the apparatus for injecting the mixture of synthetic resin and weight body material according to the present invention, FIG. 5 is a view schematically showing a heating extrusion unit of the injector installed in the apparatus for injecting the mixture of synthetic resin and weight body material according to the present invention, FIG. 6 is a perspective view of a preheater installed in the apparatus for injecting the mixture of synthetic resin and weight body material according to the present invention, and FIG. 7 is a side view of the preheater installed in the apparatus for injecting the mixture of synthetic resin and weight body material according to the present invention

As shown in FIGS. 2 to 7, the apparatus for injecting the mixture of synthetic resin and weight body material according to the present invention includes a mixer 100 for mixing synthetic resin and weight body material and an injector 200 for injection-molding the synthetic resin and the weight body material mixed by the mixer 100.

The mixer 100 is characterized by including a mixing tank 110 having an inner space, in which synthetic resin and weight body material supplied into the mixing tank 110 are mixed, and a pair of quantitative tanks 120 for supplying a fixed amount of synthetic resin and weight body material into the mixing tank 110. The injector 200 is characterized by including a heating extrusion unit 210 for heating a fixed amount of a mixture of synthetic resin and weight body material to melt the mixture and a molding unit 220 for molding the mixture melted by the heating extrusion unit 210 in a mold.

The molding unit 220 is well known in the art to which the present invention pertains, and therefore a detailed description thereof will be omitted.

The quantitative tanks 120 are installed above the mixing tank 110. The quantitative tanks 120 include a resin storage tank 121 for discharging a fixed amount of synthetic resin and weight body material storage tank 122 for discharging a fixed amount of weight body material.

In particular, a plurality of resin storage tanks 121 and a plurality of weight body material storage tanks 122 are installed so as to be spaced apart from each other by a predetermined distance in the vertical direction. Consequently, a fixed amount of synthetic resin and a fixed amount of weight body material are respectively discharged from the resin storage tanks 121 and the weight body material storage tanks 122 a plurality of times, and are then introduced into the mixing tank 110.

The heating extrusion unit 210 of the injector 200 is characterized by including a first hopper 211, into which synthetic resin and weight body material are introduced, and a first high-frequency heater 212 for heating the synthetic resin and the weight body material introduced into the first hopper 211 using high-frequency waves to melt the synthetic resin into a liquid state.

A first conveyance pipe 214 for conveying the synthetic resin and the weight body material from the first hopper 211 to the first high-frequency heater 212 is installed between the first hopper 211 and the first high-frequency heater 212. A first driving motor 213 for driving a conveyance screw installed in the first high-frequency heater 212 is mounted at one end of the first high-frequency heater 212 to convey the molten synthetic resin and the weight body material.

Meanwhile, a preheater 300 for melting synthetic resin into a half solid state is installed between the mixer 100 and the injector 200.

The preheater 300 is characterized by including a second hopper 310, into which a fixed amount of synthetic resin and weight body material mixed by the mixer 100 are introduced, and a second high-frequency heater 330 for heating the synthetic resin and the weight body material introduced into the second hopper 310 using high-frequency waves to melt the synthetic resin into a half solid state.

A second conveyance pipe 320 for conveying the half-solid synthetic resin and the weight body material from the second hopper 310 to the second high-frequency heater 330 is installed between the second hopper 310 and the second high-frequency heater 330. A second driving motor 340 for driving a conveyance screw installed in the second high-frequency heater 330 is mounted at one end of the second high-frequency heater 330 to convey the half-solid synthetic resin and the weight body material.

Consequently, the half-solid synthetic resin is supplied to the first hopper 211 installed in the heating extrusion unit 210 of the injector 200, whereby the injector 200 can injection-mold products very quickly.

The first high-frequency heater 212 and the second high-frequency heater 330 heat the weight body material and the synthetic resin to a temperature of 300 to 400° C. As a result, the weight body material, which is a metal material, is not melted, but only the synthetic resin is melted.

In addition, the first conveyance pipe 214, which is installed between the first hopper 211 and the first high-frequency heater 212 of the heating extrusion unit 210 of the injector 200, and the second conveyance pipe 320, which is installed between the second hopper 310 and the second high-frequency heater 330 of the preheater 300, are inclined such that the synthetic resin and the weight body material can be smoothly conveyed to the first high-frequency heater 212 and the second high-frequency heater 330.

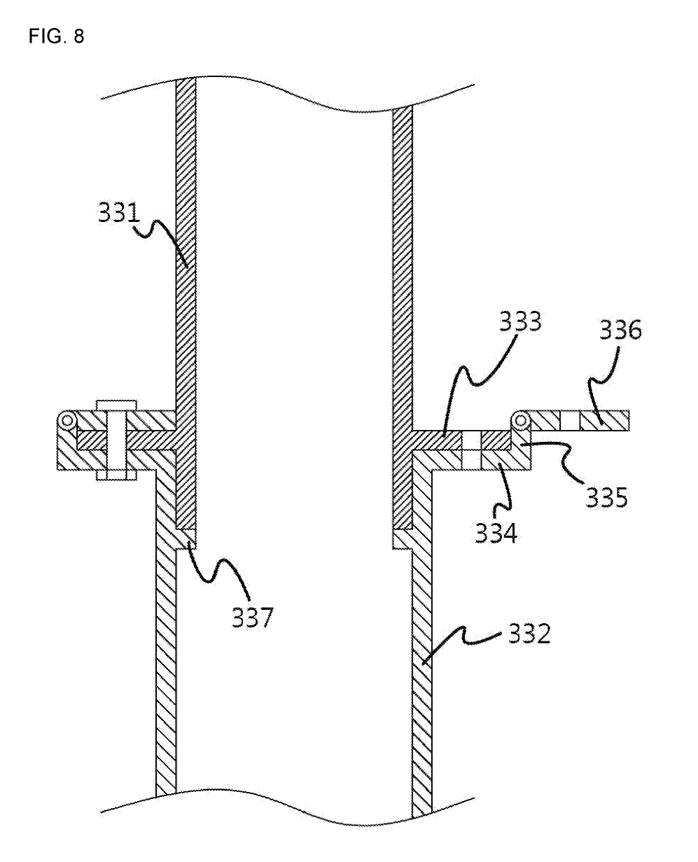

FIG. 8 is a sectional view schematically showing another embodiment of the preheater installed in the apparatus for injecting the mixture of synthetic resin and weight body material according to the present invention.

As shown in FIG. 8, the second high-frequency heater 330 of the preheater 300 includes an upper pipe 331 and a lower pipe 332, which are fastened to each other via a pair of upper and lower flanges 333 and 334. The end of the upper pipe 331 protrudes further downward than the upper flange 333 so as to be inserted into the lower pipe 332.

That is, the outer circumferential surface of the upper pipe 331 contacts the inner outer circumferential surface of the lower pipe 332.

An upwardly protruding piece 335 is formed at the edge of the lower flange 334, which is formed at the end of the lower pipe 332, and a turning piece 336 is hinged to the upper end of the protruding piece 335 so as to turn upward and downward.

In addition, a ring-shaped catching protrusion 337 protrudes from the inner outer circumferential surface of the lower pipe 332 so as to contact the end of the upper pipe 331.

The upper pipe 331 and the lower pipe 332 of the second high-frequency heater 330 are fastened to each other as follows. The upper pipe 331 is inserted into the lower pipe 332 such that the upper flange 333 and the lower flange 334 contact each other, and then the turning piece 336, which is hinged to the protruding piece 335 of the lower flange 334, is turned such that the turning piece 336 contacts the top surface of the upper flange 333.

Consequently, the upper pipe 331 may be stably rotated to a desired direction in the state in which the upper pipe 331 is inserted in the lower pipe 332. After the upper pipe 331 is rotated to the desired direction, the through holes formed in the upper flange 333 and the lower flange 334 are aligned with each other, bolts are inserted through the through holes, and nuts are fastened to the respective bolts. As a result, the upper pipe 331 is further stably fastened to the lower pipe 332.

Vertical through holes are formed in the upper flange 333, the lower flange 334, and the turning piece 336. When the upper flange 333, the lower flange 334, and the turning piece 336 are fastened to each other, the through holes formed in the upper flange 333, the lower flange 334, and the turning piece 336 are aligned along the same vertical line.

A plurality of turning pieces 336 is arranged in a fan shape. Each turning piece 336 is hinged to the protruding piece 335 so as to smoothly turn upward and downward about a hinge shaft.

The above structure is applied not only to the second high-frequency heater 330 of the preheater 300, but may also be applied to the first high-frequency heater 212 of the injector 200. In addition, several pairs of upper and lower pipes 331 and 332 may be provided. In this case, the pipes that are located at relatively high positions may be referred to as upper pipes, and the pipes that are located at relatively low positions may be referred to as lower pipes.

The present invention is configured to perform injection molding using environmentally friendly materials and regenerated energy resources, whereby the production time is reduced compared to a conventional mortar injection and extrusion type injection method. Consequently, the present invention has the effect of improving productivity. In addition, the manufacturing process is simplified. Consequently, the present invention has the effect of reducing labor costs. Furthermore, the defect rate is reduced. Consequently, the present invention has the effect of improving quality.

Moreover, poorly processed materials are pulverized for reuse. Consequently, the present invention has the effect of reducing waste treatment costs and the consumption of raw materials, thereby improving price competitiveness.

1. A method of manufacturing a mixture of synthetic resin and weight body material added to increase the weight of the mixture, the method comprising:
a first step of introducing synthetic resin and weight body material into a mixer;
a second step of mixing the synthetic resin and the weight body material in the mixer;
a third step of discharging a fixed amount of the mixture of synthetic resin and weight body material, mixed in the mixer;
a fourth step of melting the synthetic resin discharged from the mixer;
a fifth step of molding the molten synthetic resin and the weight body material into a finished product using an injector, in which a mold is mounted; and
a sixth step of cooling the finished product.

2. The a method according to claim 1, wherein
the weight body material is any one selected from between iron oxide and aluminum oxide, and a weight of the weight body material is 10 to 75% of a total weight of the mixture.

3. The method according to claim 2, wherein the synthetic resin is any one selected from between regenerated polypropylene (PP) and regenerated polyethylene (PE).

4. The method according to claim 1, wherein the mixture further comprises 0.3 to 5 weight % of a coloring agent, 10 to 20 weight % of a filler, 0.2 to 1 weight % of a processing aid, 0.2 to 0.5 weight % of an antioxidant, and 0.3 to 5 weight % of a compound, and a remainder of the mixture is the synthetic resin.

5. A mixture of synthetic resin and weight body material manufactured using a method according to claim 1.
